(19) United States
(12) Patent Application Publication
(10) Pub. No.: US 2013/0145409 A1
(43) Pub. Date: Jun. 6, 2013

(54) SYSTEM AND METHOD FOR MEDIA CONTENT DELIVER

(71) Applicant: Lawrence D. Vince, Lansdale, PA (US)

(72) Inventor: Lawrence D. Vince, Lansdale, PA (US)

(73) Assignee: GENERAL INSTRUMENT CORPORATION, Horsham, PA (US)

(21) Appl. No.: 13/308,823

(22) Filed: Dec. 1, 2011

(51) Int. Cl. H04N 21/258; H04N 21/4227

(52) U.S. Cl. 725/93; 725/153

(57) ABSTRACT

A system and method for media content delivery is described. One implementation of the system and method allows for interactive services to be ordered and delivered to a limited-capability set-top box. A gateway unit receives interactive service commands from the remote control of the set-top box through one communication path (such as a wireless path) and relays those commands to a media content network. The media content network then delivers media content in response to the interactive service commands through another communication path (such as a wired path).

### FIELD OF THE INVENTION

The present invention relates generally to interactive media and more specifically to a method and system for controlling the delivery of media content to an electronic device.

### BACKGROUND

Ever since the widespread introduction of digital television, the market demand for interactive television services has grown considerably. Consumers increasingly expect to be able to perform many non-traditional functions using these services, including ordering on-demand movies and television shows, shop for merchandise, and browse the web. Unfortunately, many low-end digital set-top boxes lack the ability to facilitate access to these interactive services because they are capable only of receiving content from the cable or satellite network, not transmitting commands to the network.

### BRIEF DESCRIPTION OF THE DRAWINGS

Various embodiments of the present invention will be described below in more detail, with reference to the accompanying drawings.

It is to be noted, however, that the appended drawings illustrate embodiments of this invention and are therefore not to be considered limiting of its scope, for the invention may admit to other equally effective embodiments. For example, the embodiments of the invention described herein can be realized in hardware, software, or a combination of hardware and software.

FIG. 1 illustrates an embodiment of the invention;

FIG. 2 illustrates a more specific embodiment of the invention;

FIG. 2a illustrates a possible implementation of the remote gateway of FIG. 2; and

FIGS. 3-5 are flow diagrams illustrating the interaction between various devices depicted in FIG. 2 according to an embodiment of the invention.

### DETAILED DESCRIPTION

In accordance with the foregoing, a system and method for media content delivery will now be described. In an embodiment of the invention, the system and method allow a cable television or satellite television customer who only has a simple, one-way set-top box to experience interactive television. In one embodiment, the customer is provided with a remote gateway that can receive signals from the customer's remote control (the remote control that is used to control the one-way set-top box). The remote gateway is attached to the customer's internal network and is capable of communicating with the cable or satellite television company (e.g., via cable or publicly-switched telephone network (PSTN)). The identification number of the remote control and/or remote gateway, the internet protocol (IP) address of the remote gateway or of the customer's router, and/or the address of the customer's cable modem are registered with the cable or satellite television company.

When the customer wishes to avail of interactive television services (e.g., video on demand), the customer presses the appropriate button on the remote control. The remote control then wirelessly transmits (e.g., via radio frequency (RF) or infrared (IR)) a request along with the identification code of the remote control to the remote gateway. The remote gateway relays the request (inserting it, for example, into an IP packet) to the cable or satellite television company (e.g., to a cable headend). The media content network of a cable or satellite company then looks up the identification number of the remote control to determine the identity and network address of the set-top box registered with the remote control as well as the IP address of the gateway unit, cable modem, or router. The media content network then delivers media content (such as an on-screen menu or an on-demand movie or television show) to the set-top box associated with the registered remote control.

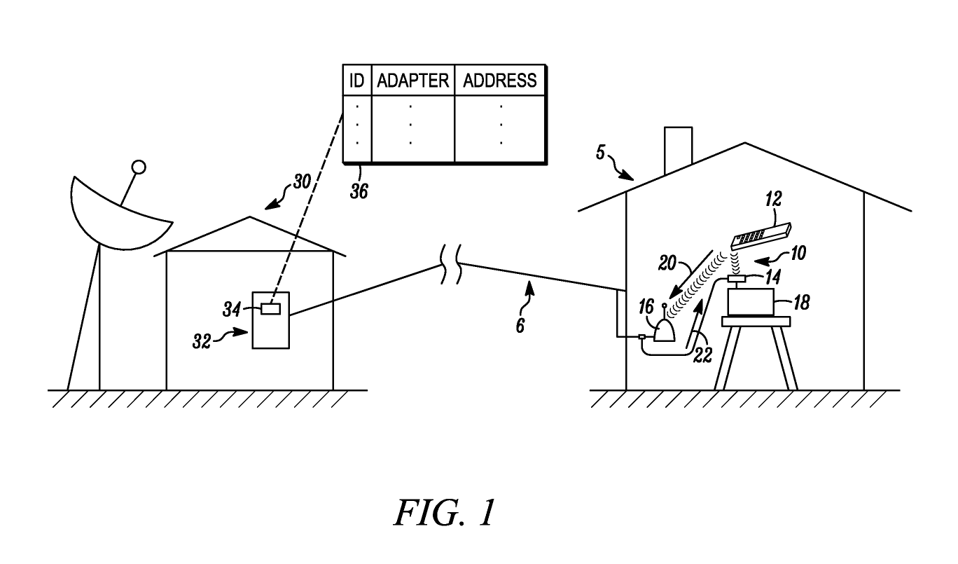

Referring to FIG. 1, an embodiment of the invention will now be described. In this embodiment, a headend 30 of a media content network (such as a cable television network or satellite television network) delivers media content to multiple customer premises. One such customer premises is a home 5. The home 5 receives the media content from the headend 30 via a data link 6. The data link 6 may include a coaxial cable, fiber optic cable, or a radio frequency link and may have many network elements in between (such as a hybrid fiber-coaxial (HFC) network). The headend 30 includes a headend unit 32 communicatively linked to a memory 34. The headend unit 30 provides media content that is stored within the memory 34 and/or received from other devices at the headend 30. The headend unit 32 may be implemented as a rack-mounted computer executing virtual set-top box software. The virtual set-top box software allows the headend unit 32 to keep track of what state the digital adapter 14 is in. The memory 34 may be implemented as a disc array or other mass storage device. The home 5 contains a media system 10 that includes a remote control 12, digital adapter 14, a gateway unit 16 and video display unit 18. In one implementation, the digital adapter is a Motorola DTA 100 and the video display unit 18 is a television set. Other implementations of the video display device 18 include an audio-visual system, a game console or a digital video recorder (DVR). In some embodiments, the digital adapter 14 is integrated within the video display device 18. The remote control 12 in one embodiment is associated or paired with the digital adapter 14.

The gateway unit 16 is communicatively linked to the headend device 32 via the data link 6 so that the gateway unit 16 can transmit data to the headend device 32. The digital adapter 14 receives media content from the headend 30 and manipulates the media content so that it can be used by the video display device 18. For example, the digital adapter 14 may receive compressed and scrambled digital video signals in a quadrature amplitude modulated (QAM) format and convert those signals into analog NTSC or PAL signals that can be used by an analog television, or into high-definition multimedia interface (HDMI) that can be used by a high-definition television. The memory 34 of the headend device 32 stores data that correlates the identification number of the remote control 14 with the digital adapter 12 as well as data correlating the network address of the house 5 with the digital adapter 14. This data may, for example, be stored in a data structure 36 in the memory 34. The remote control 12 wirelessly (e.g., over infrared or radio frequency) transmits (in response, for example, to user input on a keypad or touchscreen of the remote control 12) commands for controlling the digital adapter 14. In response to these commands, the digital adapter 14 performs functions like changing its selection of digital content that it is providing to the video display device 18 (e.g., tuning to a different cable channel) and lowering or raising the volume of the media content. In some embodiments, the remote control 12 also controls the functions of the video display device 18, including power on and power off.

Continuing the description with respect to FIG. 1, the remote control 12 is capable of generating commands for controlling media content. The commands may be generated in response to a user actuation of a button (physical, or virtual on a touchscreen) on the remote control 12. The remote control 12 also has an identification number (stored, for example, in its read-only memory) that identifies the remote control 12. During operation, the remote control 12 transmits the commands along with the identification number over a first communication path 20. Some of the transmitted commands are acted upon by the digital adapter 14, such as “power on,” “channel up,” “channel down,” “volume up,” volume down.” Any of the transmitted commands may be relayed by the gateway unit 16 to the headend device 32, including “on demand,” “play,” “fast forward,” “rewind,” “pause,” or “stop.” When the headend device 32 receives the relayed commands and identification number from the gateway unit 16, the headend device 32 uses the identification number to reference the data structure 36 in the memory 34 to determine the identity of the home 5 and the digital adapter 14. In response, the headend device 32 transmits media content to digital adapter 14 via the data link 6. The media content arrives at the home 5 and is delivered to the digital adapter 14 via a second communication path 22. In one embodiment, the first communication path 20 is an RF4CE over Zigbee transmission and the second communication path 22 is a coaxial cable.

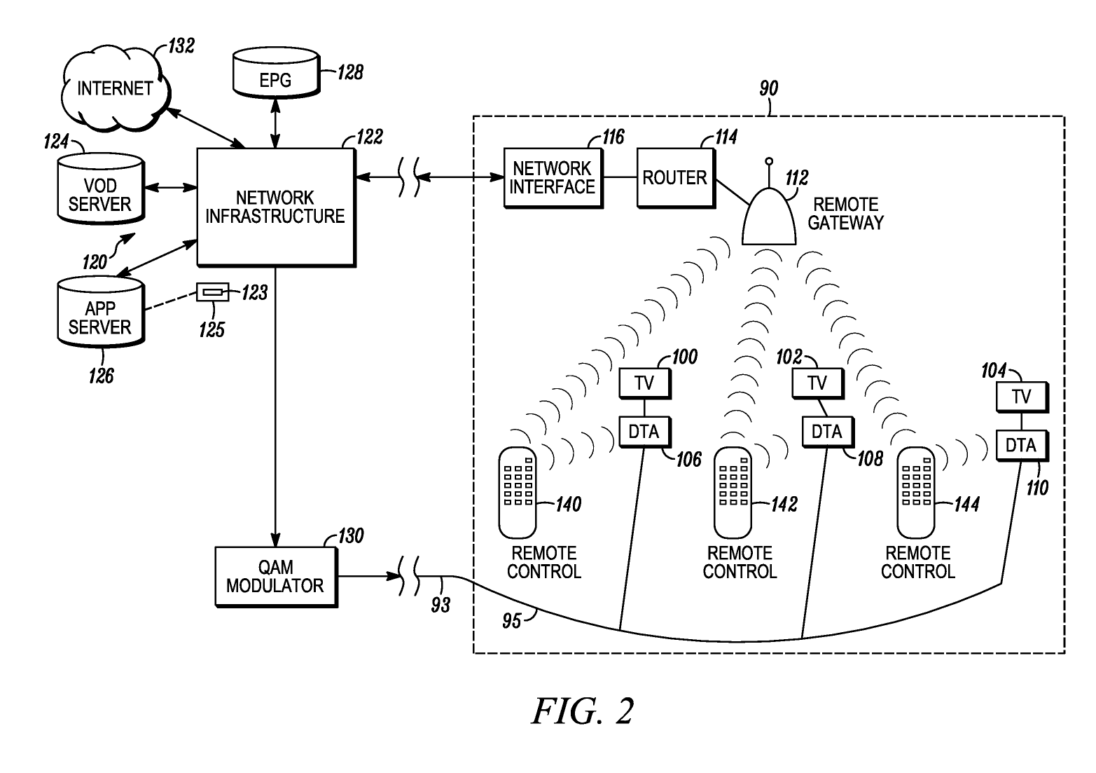

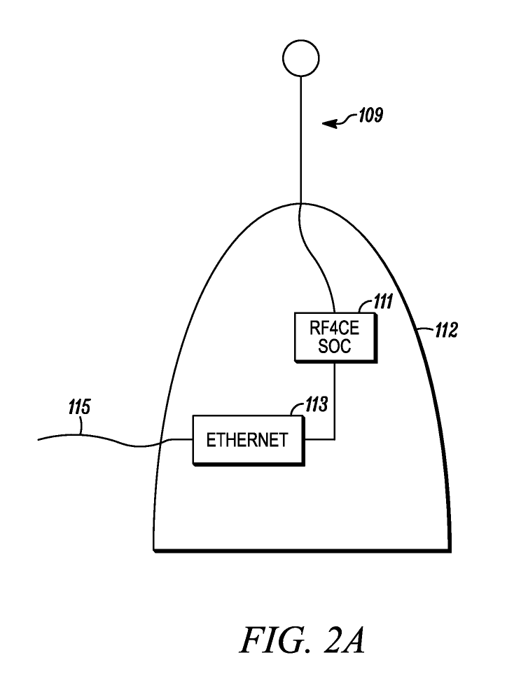

A more specific embodiment of the invention will now be described with reference to FIG. 2. In this embodiment, located at a customer's premises 90 (e.g, a home or place of business) is a first television 100, a second television 102 and a third television 104. A first digital transport adapter (DTA) 106 is communicatively linked to the first television 100, a second DTA 108 is communicatively linked to the second television 102 and a third DTA 110 is communicatively linked to the third television 104. Each of the respective DTAs 106, 108 and 110 is communicatively linked to its respective television 100, 102 and 104 by, for example, a high-definition multimedia interface (HDMI) cable or a coaxial cable. Also located at the customer's premises 90 is a remote gateway 112, a router 114, and a network interface 116. The remote gateway 112 is capable of both wired and wireless communications and is communicatively linked to the router 114 by, for example, an Ethernet cable. The router 114 is, in turn, communicatively linked to the network interface 116 by, for example, an Ethernet cable. In one embodiment, the network interface 116 is a Motorola SB6120 cable modem and the router 114 is a Linksys WRT120N Wirless N router. Located remotely from the customer's premises is a media content network 120 that includes a network infrastructure 122. Communicatively linked to the network infrastructure 122 are a video on demand (VOD) server 124, an application server 126, an electronic program guide (EPG) server 128, and a quadrature amplitude modulation (QAM) unit 130. The VOD system 124 provides video content, such as movies, to the network infrastructure 122 and the application server 126 executes one or more applications for the media content network 120, such as applications for delivering video content, delivering web content, hosting games, etc. The application server 126 may also pre-render content to minimize the load on the DTAs 106, 108 and 110. In the context of FIG. 2, the application server 126 executes virtual set-top box software. The EPG server 128 controls an electronic programming guide. When the media content network 120 provides media content, the signals carrying the media content are modulated according to a quadrature amplitude modulation technique by the QAM unit 130 prior to being transmitted to customers. The network infrastructure 122 is also communicatively linked to the Internet (represented by a cloud 132). The media content network 120 delivers data to the home 90 via an HFC network 93. The HFC network 93 is communicatively linked to an internal cable line 95 in the home 90 via a cable drop.

According to an embodiment of the invention, communication from the remote control unit 140 to the media content network 120 generally occurs as follows. The remote control 140 transmits a radio frequency (RF) signal containing a first message that includes a command and the identification number of the remote control 140. The RF link between the remote control 140 and the remote gateway 112 is an example of a first communication path. The remote gateway 112 receives the RF signals and creates a second message containing the command and the identification number. The second message may be formatted differently than the first message. For example, the second message may be formatted using a TCP/IP protocol on top of an Ethernet frame. The remote gateway 112 transmits the second message to the media content network 120 via the router 114 and the network interface 116. When the media content network 120 receives the second message, the media content network 120 uses the identification number to reference a data structure 123. The data structure 123 may be located in a memory on any device in the media content network 120, but is depicted in FIG. 2 as being stored in a memory 125 of the application server 126. By referencing the data structure, the media content network 122 can determine which remote control unit is sending the message, which customer (identified, for example by the IP address of the network interface 116) is requesting the media content, and the DTA to which the requested media content (including on-screen menus and updates to on screen menus) is to be sent. The messages may also pass through other intermediate components. The application server 126 keeps track of each of the commands (which may represent individual key presses on the remote control unit 140) so that the virtual set-top box software executing on the application server 126 can keep track of the state of the DTA 106.

Communication from the media content network 120 to each of the DTAs 106, 108 and 110 occurs as follows in an embodiment of the invention. The media content network 120 retrieves data from various devices such as the EPG server 128, the application server 126 or the VOD system 124. The data, which may include commands and media content, is sent to the QAM modulator 130. The QAM modulator 130 modulates the data and transmits the modulated data over the HFC network 93. The data reaches the DTA 106, 108, or 110 via the internal cable line 95. Each of the DTAs is separately addressable so that the media content network 120 can communicate individually with it.

There are many possible implementations of the remote gateway 112 of FIG. 2. One such implementation is shown in FIG. 2a, in which the remote gateway 112 includes an antenna 109 configured to receive RF4CE over Zigbee signals, an RF4CE system on a chip (SOC) 111 electrically connected to the antenna 109 and an Ethernet module 113 communicatively linked to the RF4CE SOC 111. The RF4CE SOC 111 executes application software that converts RF4CE-formatted commands and data into IP-formatted commands and transmits the IP-formatted commands to the Ethernet module 113. The Ethernet module 113 then inserts the IP-formatted commands into Ethernet frames and transmits the Ethernet frames via an Ethernet link 115 to, for example, the router 114 of FIG. 2. Other possible implementations of the remote gateway 112 include a dongle that plugs into a universal serial bus (USB) port of the router 114 or the network interface 116. Additionally, the remote gateway 112 may receive infrared (IR) commands instead of, or in addition to RF4CE commands.

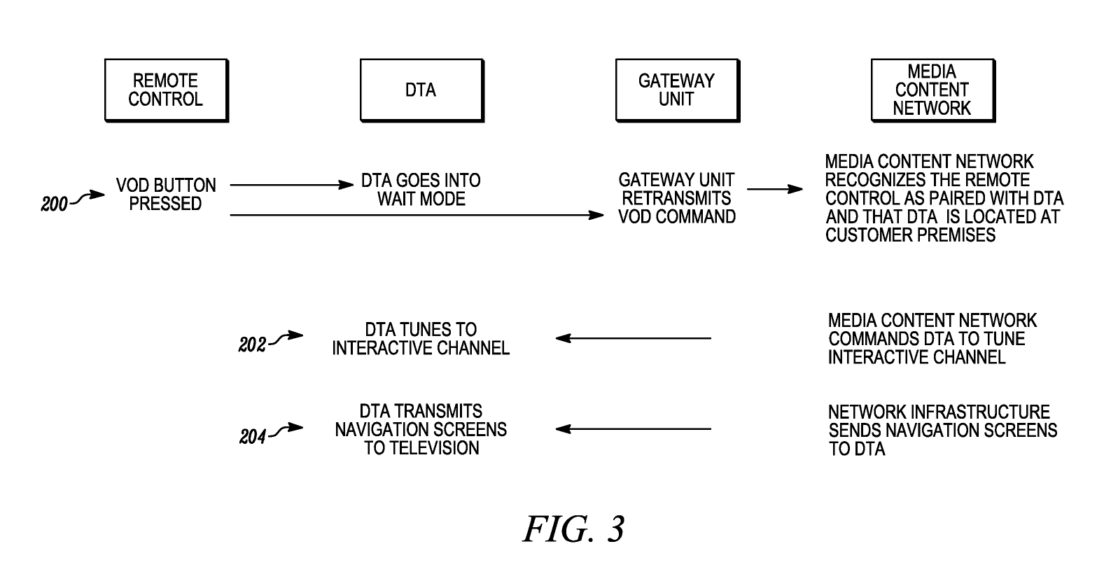

Referring to FIGS. 3, 4 and 5 with appropriate reference back to FIG. 2, an example of how a remote control sends requests for media content to a media content network and how the media content network fulfills those requests according to an embodiment of the invention will now be described. At step 200 (FIG. 3), a user presses a “Video on Demand” button on the remote control 140. In response, the remote control 140 transmits an RF signal containing a message that includes a “Video on Demand” command and the identification number of the remote control 140. In this example, the RF signal constitutes the first communication path.

The DTA 106 receives the message and, in response, goes into a wait mode in which it is ready to receive commands from the media content network 120. In some implementations, the media content network 120 controls all of the actions of the DTA 106, such that a wait mode is unnecessary. The remote gateway 112 also receives the RF signal with the message, reformats the message into IP packets, and retransmits the message to the media content network 120. At step 202, the media content network 120 generates a “Change to interactive channel” command that gets modulated by the QAM modulator 130, transmitted over the HFC network 93 and reaches the DTA 106 via the internal cable line 95. In response to the received command, the DTA 106 tunes to an interactive menu channel, which the DTA 106 provides to the television 100 for display. In this example, the internal cable line 95 constitutes a second communication path. At step 204, the media content network 120 generates one or more navigation screens, which are modulated by the QAM modulator 130, transmitted over the HFC network 93 and are received by the DTA 106 via the internal cable line 95. The DTA 106 transmits the navigation screens to the television 100. The navigation screens allow a user to make selections by viewing the available selections on the navigation screens (displayed on the television 100) and pressing the appropriate button (or touchscreen control) on the remote control 140.

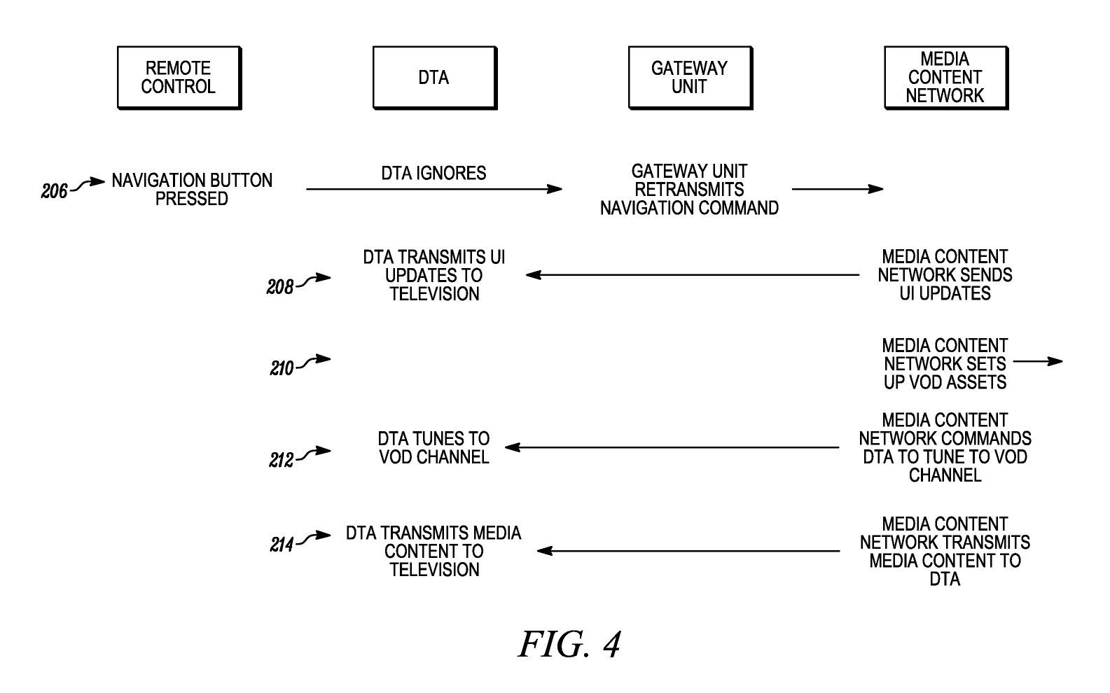

When the user presses navigation buttons on the remote control 140, the navigation screen is updated to reflect this fact. Referring to FIG. 4, at step 206 the remote control 140 receives a navigation button press (such as up, down, left, right, or select) and sends a message with the appropriate command and identification number (via the first communication path and as described in conjunction with step 200) to the remote gateway 112 which, in turn, sends the message to the media content network 122. The DTA 106 ignores the message. At step 208, the media content network 122 responds by sending an update via the second communication path to the navigation screen to the DTA 106 that reflects the navigation. For example, the update might show a different item on a selection menu being highlighted. If the user input reflects a valid selection of media content (e.g., where an on-demand movie was highlighted on the navigation screen and the user pressed “select” on the remote control), then the media content network 120 sets up a VOD asset at step 210. In doing so, the media content network 120 may retrieve a movie stored on the VOD system 124. At step 212, the media content network 120 sends a command to the DTA 106 ordering the DTA 106 to tune to a VOD channel. The DTA 106 responds by tuning to the VOD channel. At step 214, the media content network 122 transmits the media content (e.g., an on-demand movie or TV show) to the DTA 106 which, in turn, provides the content to the TV 100. It should be noted that the media content may be any of a number of types, including web pages, video sharing content (e.g., YouTube videos) and may be pre-rendered by the application server 126.

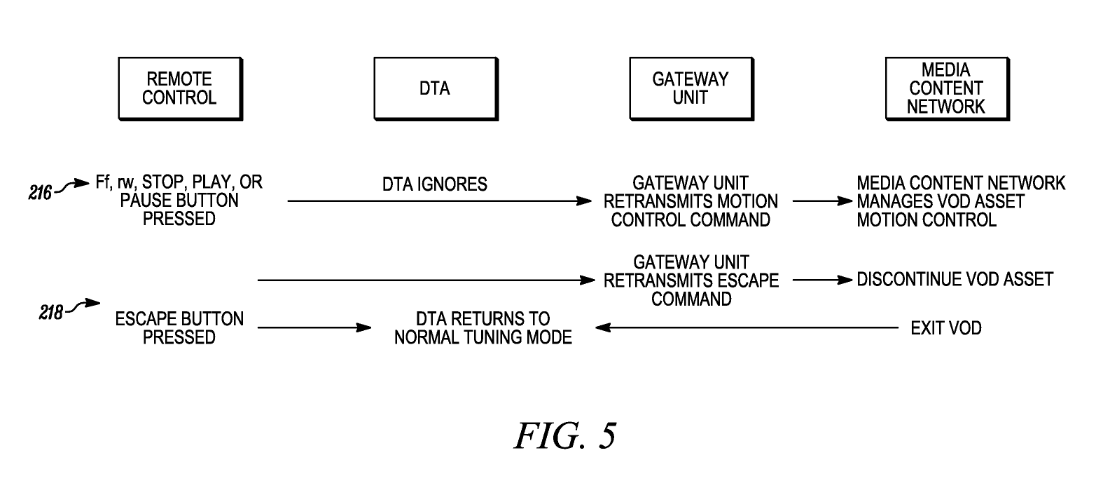

Referring to FIG. 5, the user may control the delivery of the media content to the DTA 106 by using motion controls on the remote control 140. At step 216, for example, the user presses the fast forward, rewind, stop, play or pause button on the remote control 140. In response, the remote control 140 sends a message that includes the appropriate command (e.g., fast forward, rewind, stop, play or pause) and the identification number of the remote control 140 to the remote gateway 112 via the first communication path. The DTA 106 ignores the message. The remote gateway 112 reformats the message as IP packets and transmits the reformatted message to the media content network 122 via the network interface 116. The media content network 120 manages the VOD asset according to the command, such as by causing it to speed up, rewind, etc. At step 218, the user presses the escape button on the remote control 140. In response, the remote control sends a message that includes an “Escape” command and the identification number of the remote control 140 to the remote gateway 114. The remote gateway reformats the message as IP packets and transmits the reformatted message to the media content network 122 via the network interface 116. The message is also received by the DTA 106. In response, the DTA 106 returns to a normal tuning mode and the media content network 120 ceases delivering the VOD content.

The flowchart and block diagrams in FIGS. 1-5 illustrate the architecture, functionality, and operation of possible implementations of systems and methods according to various embodiments of the present invention. In this regard, procedures outlines (for example, in data flow diagrams of FIGS. 3-5) may be implemented as a module, segment, or portion of code, which comprises one or more executable instructions for implementing the specified functions. It should also be noted that, in some alternative implementations, the functions noted may occur out of the order noted in the figures or in the text. For example, two steps shown or described in succession may, in fact, be executed substantially concurrently, or the steps may sometimes be executed in the reverse order, depending upon the functionality involved.

This invention can be embodied in other forms without departing from the spirit or essential attributes thereof. Accordingly, reference should be made to the following claims as indicating the scope of the invention.

What is claimed is:

1. A system for controlling media content delivery to an electronic device, the system comprising:
a remote control configured to transmit commands via a first communication path;
a gateway unit configured to receive the transmitted commands via the first communication path and relay the commands to a media content network; and
an adapter configured to receive media content from the media content network via a second communication path and providing the content to the electronic device, the remote control being paired for communication with the adapter.

2. The system of claim 1, wherein the adapter is configured to convert the received media content from a quadrature amplitude modulation format to a high definition television format and provide the converted content to the electronic device.

3. The system of claim 1, wherein the remote control is further configured to transmit an identification code that identifies the remote control to the media content network, the remote control identification code being transmitted to the media content network by the gateway unit.

4. The system of claim 1, wherein the adapter comprises a one-way converter incapable of transmitting requests for the media content to the media content network.

5. The system of claim 1, further comprising a headend device located remotely from the gateway unit and the adapter, the headend device comprising a memory having stored thereon a data structure that correlates the remote control with the adapter.

6. The system of claim 5, wherein the headend device is integrated with the media content network and is configured to transmit the media content from the media content network to the adapter.

7. The system of claim 1, further comprising a headend device located remotely from the gateway unit and the adapter, the headend device having the media content stored thereon.

8. The system of claim 1, wherein the electronic device is a television, and the adapter is configured to receive the media content via an on-demand channel.

9. A method for controlling media content delivery to an electronic device, the method comprising:
associating a remote control with a digital transport adapter;
receiving, at a location remote from the digital transport adapter, a command from the remote control unit via a first communication path; and,
in response to the received command, transmitting media content to the digital transport adapter via a second communication path.

10. The method of claim 9, wherein the digital transport adapter is one of a plurality of digital transport adapters, the method further comprising:
storing data representing the association between the remote control and the digital transport adapter in a data structure;
receiving, at the remote location, an identification code from the remote control; and
referencing the data structure using the identification code to distinguish the digital transport adapter from the plurality of digital transport adapters.

11. The method of claim 9, wherein the remote location is a cable headend facility and the media content is on-demand video.

12. The method of claim 9, wherein the first communication path is a wireless radio frequency communication path and the second communication path is a wired communication path.

13. A system for enabling video on demand, the system comprising:
a digital transport adapter communicatively linked with a media content network, the digital transport adapter configured to receive video content from the media content network and deliver the video content to a video display device, but incapable of transmitting requests for the video content to the media content network;
a remote control configured to transmit requests for the video content and to control the operation of the digital transport adapter; and
a gateway unit configured to receive the transmitted requests and relay the received requests to the media content network.

14. The system of claim 13, wherein the digital transport adapter comprises a converter configured to convert the received video content from a quadrature amplitude modulated format to a high-definition multimedia interface format and deliver the converted video content to the video display device.

15. The system of claim 13, wherein the gateway unit is further configured to receive the transmitted requests via a wireless communication medium and relay the received requests via a wired communication medium.

16. The system of claim 13, further comprising a network interface having a network address, wherein the network interface is configured to receive the relayed requests from the gateway unit, add the network address to the requests, and transmit the requests to the media content network.

17. The system of claim 13, further comprising a headend device integrated with the video content network, the headend device comprising a memory having the video content stored therein, the headend device being configured to send the video content from the video content network.

18. The system of claim 13, further comprising a headend device comprising a memory, the memory having stored thereon a data structure that correlates the remote control with the digital transport adapter,
wherein the remote control is further configured to transmit a code that identifies the remote control, and
wherein the headend device is configured to use the code to reference the data structure to determine the identity of the digital transport adapter.

19. The system of claim 18, further comprising a network interface having a network address,
wherein the network interface is configured to receive the relayed requests from the gateway unit, add the network address to the requests, and transmit the requests to the media content network, and
wherein the headend device is further configured to use the code to reference the data structure to determine the network address.

20. The system of claim 13,
wherein the digital transport adapter comprises a digital to analog adapter configured to convert the video content from a digital format to an analog format and deliver the converted video content to the video display unit,
wherein the media content network is a cable television network, and
wherein the digital transport adapter and the gateway unit are located at the premises of a subscriber of the cable television network.
